(19) United States
(12) Patent Application Publication
(10) Pub. No.: US 2010/0270170 A1
(43) Pub. Date: Oct. 28, 2010

(54) SYSTEM AND PROCESS FOR CONVERTING NON-FRESH WATER TO FRESH WATER

(75) Inventor: Itzhak Rosenbaum, Markham (CA)

Correspondence Address: STIKEMAN ELLIOTT LLP, 1600-50 O''CONNOR STREET, OTTAWA, ON, K1P 6L2, CA

(73) Assignee: HTE Water Corporation, Markham (CA)

(21) Appl. No.: 12/428,153

(22) Filed: Apr. 22, 2009

(51) Int. Cl. C02F 1/461; C02F 1/02; C25B 9/00

(52) U.S. Cl. 205/742; 210/175; 204/274; 60/645; 60/670

(57) ABSTRACT

A method of converting seawater, waste water, brackish water and polluted water to fresh water, referred to as “The Rosenbaum-Weisz Process”, is disclosed. This method utilizes high temperature electrolysis to decompose the seawater into hydrogen, oxygen and salts/minerals. The generated hydrogen and oxygen are then combusted in a high temperature combustor to generate superheated steam. The heat from the superheated steam is then removed by a high temperature heat exchanger system and recycled to the high temperature electrolysis unit. The superheated steam is then condensed, as a result of the heat extraction by the heat exchanger system, to produce fresh water. The recovered salts/minerals can be sold to generate additional revenue.

### FIELD OF THE INVENTION

The present invention relates to the conversion of non-fresh water and in particular seawater, waste water, brackish water, polluted water and the like, to fresh water.

### DESCRIPTION OF THE PRIOR ART

Water is one of the most vital natural resources for all life on Earth. The availability and quality of water has always played an important part in determining not only where people can live, but also their quality of life. Domestic use includes water that is used in the home every day such as for drinking, food preparation, bathing, washing clothes and dishes, flushing toilets, and watering lawns and gardens. Commercial water use includes fresh water for motels, hotels, restaurants, office buildings, other commercial facilities, and civilian and military institutions. Industrial water use is a valuable resource to a nation's industries for such purposes as processing, cleaning, transportation, dilution, and cooling in manufacturing facilities. Major water-using industries include steel, chemical, paper, and petroleum refining. Water is used in the production of electricity in thermoelectric power plants that are fueled by fossil fuels, nuclear fission, or geothermal. Irrigation water use is water artificially applied to farm, orchard, pasture, and horticultural crops, as well as water used to irrigate pastures, for frost and freeze protection, chemical application, crop cooling, and harvesting. Livestock water use includes water for stock animals, feed lots, dairies, fish farms, and other nonfarm needs. Water is needed for the production of red meat, poultry, eggs, milk, and wool, and for horses, rabbits, and pets.

The planet's water reserves are estimated at 1,304,100 teratons (1 teraton is 10¹² tons) of which freshwater reserves only account for 2.82% of this figure. Agriculture consumes 70% of the world's freshwater, industry 20% and households 10%. Between 1900 and 1995, drinking water demand grew twice as fast as the world population. By 2025, this demand should grow another 40%. In fifty years, the Canadian Agency for International Development has predicted that some forty countries could lack adequate drinking water. This will inevitably lead to conflict, even wars, as local areas, provinces and countries will go to any length to defend their fresh water resources.

Almost all conventional power plants, including coal, oil, natural gas, and nuclear facilities, employ water cycles in the generation of electricity. Recently available data from the U.S. Geologic Survey shows that thermoelectric power plants, in the U.S.A., use more than 195 billion gallons of water per day. Such immense water needs produce equally immense concerns given the likelihood of future droughts and shortages, especially during the summer months. The addition of new conventional power plants therefore, has inherent water-related risks that may result in electric utilities no longer able to construct them.

In Canada, there are vast oil sand resources estimate at 1.7 trillion barrels (270×10⁹ m³) of bitumen. Water is required to convert bitumen into synthetic crude oil. A recent report by the Pembina Institute shows that it requires about 2-4.5 m³ of water to produce one cubic metre (m³) of synthetic crude. The need for industrial water use will increase with population growth and global warming as the demand for fuel and electricity increases.

According to recent numbers by UNICEF and the World Health Organization, there are an estimated 884 million people without adequate drinking water, and a correlating 2.5 billion without adequate water for sanitation (e.g. wastewater disposal). Also, cross-contamination of drinking water by untreated sewage is the chief adverse outcome of inadequate safe water supply. Consequently, disease and significant deaths arise from people using contaminated water supplies; these effects are particularly pronounced for children in underdeveloped countries, where 3900 children per day die of diarrhea alone. The greatest irony is that 97% of the water exists as seawater which is unfit for human consumption. Consequently, as the world population grows it is increasingly important to find ways to produce fresh water such as by converting non-fresh water and in particular seawater, waste water, brackish water and polluted waters to fresh water. “Fresh water” as used herein is potable water.

Seawater contains about 3% salts and minerals, with 97% of the seawater being water. Brackish water contains more than 500 ppm of salts but less than sea water, which has between 34,000 to 36,000 ppm of salt. Desalination refers to any of several processes that convert seawater to fresh water. Sometimes the process produces table salt as a by-product. It is also used on many seagoing ships and submarines.

The two most popular desalination technologies are Multi Stage Flash Distillation (MSF) and Reverse Osmosis (RO), or some variations of them, which account for about 90% of the technologies that desalinate seawater across the globe. Most desalination plants convert only about 30%-60% of the seawater to fresh water.

Multi-stage flash distillation (“MSF”) is a desalination process that distills sea water by flashing a portion of the water into steam in multiple stages of what are essentially regenerative heat exchangers. Seawater is first heated in a container known as a brine heater. This is usually achieved by condensing steam on a bank of tubes carrying sea water through the brine heater. Heated water is passed to another container known as a “stage”, where the surrounding pressure is lower than that in the brine heater. It is the sudden introduction of this water into a lower pressure “stage” that causes it to boil so rapidly as to flash into steam. As a rule, only a small percentage of this water is converted into steam. Consequently, it is normally the case that the remaining water will be sent through a series of additional stages, each possessing a lower ambient pressure than the previous “stage.” As steam is generated, it is condensed on tubes of heat exchangers that run through each stage. MSF distillation plants, especially large ones, are paired with power plants in a cogeneration configuration where the waste heat from the power plant is used to heat the seawater rather than generate electricity or be used in an industrial/chemical process. The power plants consume large amounts of fossil fuels thereby contributing significantly to global warming. The world's largest MSF desalination plant is the Jebel Ali Desalination Plant located in the United Arab Emirates and is capable of producing 820,000 cubic meters (215 million gallons/day) of fresh water per day.

Reverse Osmosis (“RO”) is a filtration process typically used for water. It works by using pressure to force a solution through a membrane, retaining the solute on one side and allowing the pure solvent to pass to the other side. This is the reverse of the normal osmosis process, which is the natural movement of solvent from an area of low solute concentration, through a membrane, to an area of high solute concentration when no external pressure is applied. The largest Sea Water Reverse Osmosis (SWRO) installation is built in Ashkelon, Israel capable of producing 320,000 cubic meters of fresh water per day. The Ashkelon plant has a dedicated 80 MW gas turbine to supply the required electrical need. The Tampa Bay plant (the largest in North America) takes 44 million gallons of seawater and converts it to 25 million gallons (95,000 cubic meters) of fresh water every day (a 56.8% conversion rate).

Electrolysis of water is the decomposition of water (H₂O) into oxygen (O₂) gas and hydrogen (H₂) gas due to an electric current being passed through the water. An electrical power source is connected to two electrodes, or two plates, (typically made from some inert metal such as platinum or stainless steel) which are placed in the water. Hydrogen will appear at the cathode (the negatively charged electrode, where electrons are pumped into the water), and oxygen will appear at the anode (the positively charged electrode). The generated amount of hydrogen is twice the amount of oxygen, and both are proportional to the total electrical charge that was sent through the water. Electrolysis of pure water is very slow, and can only occur due to the self-ionization of water. Pure water has an electrical conductivity about one millionth that of seawater. It is sped up dramatically by adding an electrolyte (such as a salt, an acid or a base). Electrolysis at normal conditions (25° C. and 1 atm) is completely impractical for electrolyzing water for anything but a small lab experiment. The electrical energy required to electrolyze water to get hydrogen & oxygen at 25° C. and 1 atm is 4,397 kWh/m³. Assuming an electrical rate of $0.05/kWh, and using the electrolysis process at the Tampa Bay plant, having an output 95,000 m³/day, the electrolysis electrical cost would be about $21 million/day ($7.7 billion per year) and for the Jebel Ali plant, having an output of 820,000 m³/day, the electrolysis electrical cost would be about $180 million/day ($65.7 billion per year).

High-temperature electrolysis (“HTE”), also known as steam electrolysis, is the same concept as electrolysis except that it occurs at high temperatures. High temperature electrolysis is more efficient economically than traditional room-temperature electrolysis because some of the energy is supplied as heat, which commercially is generally less expensive to supply than electricity, and because the electrolysis reaction is more efficient at higher temperatures.

As the temperature increases, the efficiency of the electrical conversion of water to hydrogen increases. In fact, at about 2500° C., electrical input is unnecessary because water breaks down to hydrogen and oxygen through thermolysis. The efficiency improvement of high-temperature electrolysis is best appreciated by assuming that the electricity used comes from a heat engine, and then considering the amount of heat energy necessary to produce one kg hydrogen (141.86 mega joules), both in the HTE process itself and also in producing the electricity used. At 100° C., 350 mega joules of thermal energy are required (41% efficient). At 850° C., 225 mega joules are required (64% efficient).

As we go to higher temperatures, the energy necessary for electrolysis comes from heat (thermal energy) rather than electricity. It is known that at around 1000° C., about 70% of the energy requirement comes from electricity and about 30% can come from heat. This increases the efficiency and reduces the cost significantly.

Thermal decomposition, also called thermolysis, is defined as a chemical reaction when a chemical substance breaks up into at least two chemical substances when heated. The reaction is usually endothermic as heat is required to break chemical bonds in the compound undergoing decomposition. The decomposition temperature of a substance is the temperature at which the substance decomposes into smaller substances or into its constituent atoms. As explained previously, water will decompose to its elements at temperatures around 2500° C. In this case the entire required energy for hydrogen and oxygen production is completely provided by heat and no electricity is necessary.

As discussed above, fresh water scarcity is a growing problem in many parts of the world. However, in parts of the world where fresh water is more abundant, the fresh water supply can also be threatened, not by scarcity, but rather by contamination. For example, an investigation by the Associated Press has revealed that the drinking water of at least 41 million people in the United States is contaminated with pharmaceutical drugs. It has long been known that drugs are not wholly absorbed or broken down by the human body. Significant amounts of any medication taken eventually pass out of the body, primarily through the urine. While sewage is treated before being released back into the environment and water from reservoirs or rivers is also treated before being funneled back into the drinking water supply, none of these treatments are able to remove all traces of medications.

Medications for animals are also contaminating the water supply. Drugs given to animals are also entering the water supply. One study found that 10 percent of the steroids given to cattle pass directly through their bodies. Another study found that steroid concentrations in the water downstream of a Nebraska feedlot were four times as high as the water upstream. Male fish downstream of the feedlot were found to have depressed levels of testosterone and smaller than normal heads, most likely due to the pharmaceutical contamination in their water.

In most modern cities, rivers and lakes, within their vicinity have become the focal point of business, resulting in heavy development and commercialization of these primary natural resources. The Seine River in Paris, the Singapore River in the Lion City, the Chao Phraya in Bangkok and the Thames in London, to name just a few famous ones, have all been turned into tourist destinations with massive commercial development around them. In all these cities, businesses flourish along their river corridors and the aesthetic values the rivers offer to the city denizens such as scenic beauty, solitude, natural environment cannot be described with words but need to be experienced. But, there is a heavy price to pay for the massive economic development and the booming commercial activities along these rivers and within their vicinity. These rivers are slowly being killed by the unrestrained development which is often accompanied by massive pollution and other ecological damage.

Conventional desalination methods (most notably Multi-Stage Flashing and Reverse Osmosis) can help to close the gap between the supply and demand of fresh water. However, these desalination methods require a lot of capital expenditures and consume an enormous amount of fossil fuels. The sad reality is that the countries that need the fresh water most are the developing countries (and in many cases the poorest countries) who do not have the required capital and can not afford to purchase the enormous annual amount of fossil fuel that is required to operate these plants.

In the last decade, there has been much discussion about using nuclear energy to provide the required energy for the desalination plants. While nuclear plants may offer some solutions, they also create many other problems. Nuclear plants require significant capital, take a long time to be put in place (permitting, construction etc.) and require the availability of highly trained staff to run the plants. Unfortunately, this option will not be available to most developing countries and in particular the poorest countries. In the world of instability, the last thing that the world need is the proliferation of nuclear plants that may lead to a nuclear race in many unstable regions of the world. Moreover, it is impractical to have a nuclear plant in every province much less in every village where fresh water is often needed most.

### SUMMARY OF THE INVENTION

In one aspect, the present invention relates to the conversion of seawater to fresh water using high temperature electrolysis to dissociate water to hydrogen and oxygen and to separate the minerals, and then combusting the generated hydrogen and oxygen to form superheated steam and heat, wherein a closed loop heat recovery system is utilized to recycle the heat generated by the combustion process to the high temperature electrolysis unit for the dissociation of the seawater. The extraction of heat from the superheated steam by the heat recovery system condenses the superheated steam to fresh water. This total process of generating fresh water by this invention has been given the name of “The Rosenbaum-Weisz Process” by the inventor. The reference to Rosenbaum and Weisz is in honour of the inventor's parents.

In another aspect, the present invention relates to the Rosenbaum-Weisz Process which utilizes high temperature electrolysis of seawater to produce fresh water. The required heat for high temperature electrolysis is obtained by capturing and utilizing heat that is generated by the combustion of hydrogen and oxygen. When hydrogen and oxygen are combusted, the resulting product is heat and superheated steam. The combustion temperature is around 2500° C. (same as thermolysis). The heat generated by the combustion of hydrogen and oxygen is extracted by a heat exchanger system and recycled to be used in the high temperature electrolysis process. The extraction of the heat by the heat exchanger system condenses the superheated steam into fresh water. The overall process includes the following steps: seawater treatment; evaporation of the treated seawater, high temperature electrolysis; hydrogen and oxygen production; hydrogen and oxygen storage; combustion of hydrogen and oxygen; heat exchanger recovery system; and the condensing of the superheated steam into fresh water.

The heat for the high temperature electrolysis can come from different sources. One way to create on-site heat is by burning fossil fuels such as natural gas to produce the required heat. Another way is to capture waste heat from a nearby cogeneration plant. The typical temperature of the waste heat from a cogeneration plant is between 800° C. and 1000° C. Yet another way is to locate a HTE facility near a nuclear plant thereby utilizing the heat from the nuclear plant. For HTE occurring at around 1500° C., the energy contribution can be approximately 50% from the electrical input and 50% from the heat and at around 2000° C., the energy contribution can be approximately 25% from the electrical input and 75% from the heat. At even higher temperatures, thermal decomposition occurs. It will be understood by persons of ordinary skill in the art that the ratio of electricity to thermal energy used as input energy for the HTE process can be varied according to the conditions under which the HTE operates. In general, if more heat energy is used, less electricity is required and vice versa.

If seawater is to be converted to fresh-water, the seawater is preferably pretreated to remove organics, algae, and fine particles if brackish water is used. Conventional processes can be used for the pretreatment.

If waste water or polluted water is to be converted to fresh water, pretreatment to remove waste material is preferred and conventional processes can be used for such pretreatment. The treated water is then subjected to high temperature electrolysis.

An HTE system according to the present invention can operate at just below the thermolysis temperature (just below 2500° C.). In such a system, the energy required for hydrogen and oxygen production comes mainly (can be as high as 99%) from heat generated by the combustion of hydrogen and oxygen (in a later stage of the system) and the remaining 1% from electricity. In this way, the hydrogen and oxygen production is mostly through heat, and electricity is used primarily to separate produced hydrogen and oxygen and avoid their recombination.

In one aspect, the present invention relates to converting almost all of the input seawater to fresh water where the Rosenbaum-Weisz Process has the potential of converting 97% seawater and 3% salts/mineral into 97% fresh water and 3% salts/minerals thereby providing fresh water for humans, industries, livestock and agriculture.

In another aspect, the present invention relates to a desalination system where the high temperature electrolysis units are operated at pressures greater than 1 atms. Such higher or elevated pressure reduces the volume required for the HTE and thus the volume of the electrolysis units and in turn the number of high temperature electrolysis units needed.

In a further aspect, the present invention provides to a system and method where the energy required for the HTE process is provided by harnessing the heat that is generated by the combustion of the hydrogen and oxygen (a green and renewable energy process) rather than burning fossil fuels, which are known to cause global warming.

In a still further aspect, the present invention relates to a system and method where fresh drinking water is provided from polluted waters by increasing water temperature thereby rejuvenating polluted rivers and stream, eliminating drugs and other deadly bacteria in waste treatment plants. The standard requirement for eliminating hazardous material in typical incineration process is by keeping the material at 2000° C. for 2 seconds. The present system in one embodiment provides such conditions for polluted and waste water.

In other embodiments of the present invention, a system using the Rosenbaum-Weisz Process can be installed in existing MSF desalination plants as well as RO desalination plants. Thus, the extensive non-renewable energy, that contributes significantly to global warming, that is currently being consumed can be replaced by the implementation of the Rosenbaum-Weisz Process. In the case of the MSF desalination process, the waste heat from the adjacent cogeneration plants can be used to produce electricity or be used in an industrial/chemical process, since they will not be closed down.

In another embodiment of the present invention, a new plant using the Rosenbaum-Weisz Process does not require massive investments in the construction of an adjacent cogeneration power plant. Consequently, plants employing the Rosenbaum-Weisz Process can be located anywhere in the world since they are dependant on having a cogeneration power plant beside them to supply the required energy. Plants employing the Rosenbaum-Weisz Process can be located in a small village in Africa that has a small plant to convert seawater, brackish or polluted water to fresh water or in a large metropolitan city that has large plant converting, seawater, brackish or polluted water to fresh water since they are not depended on being located near a cogeneration power plant.

In a further embodiment of the present invention, dedicated plants employing the Rosenbaum-Weisz Process can be set up to provide vast amounts of water that are required for industrial use and for power plants.

In still further embodiment of the present invention, the Rosenbaum-Weisz Process can provide fresh water from many non-fresh water sources and does not require the consumption of large amounts of non-renewable fossil fuels. Consequently, the Rosenbaum-Weisz Process can be a major contributor to the slowing down of the consumption of non-renewable fossil fuel and thus significantly contributing to the slowing down of global warming and thereby extending the life of non-renewable fossil fuel reserves.

The Rosenbaum-Weisz Process can be utilized by both rich and poor nations across the world since it requires very little purchase of external energy to operate.

### BRIEF DESCRIPTION OF THE DRAWINGS

FIG. 1 illustrates processes in high temperature electrolysis of seawater producing fresh water according to the invention.

FIG. 2 illustrates a high temperature electrolysis unit according to the present invention.

FIG. 3 illustrates a hydrogen and oxygen combustor according to the present invention.

FIG. 4 illustrates one embodiment of a heat exchanger used for extracting heat from the combustion of hydrogen and oxygen to produce superheated steam according to the present invention.

FIG. 5 illustrates one embodiment of the present process that is utilizing part of the hydrogen and oxygen for external use and sale according to the present invention.

FIG. 6 illustrates one embodiment of the present process that is utilizing part of the heat extracted from the superheated steam to generate electricity according to the present invention.

FIG. 7 illustrates one embodiment of the present process that is utilizing part of the hydrogen and oxygen for external use and sale and utilizing part of the heat extracted from the superheated steam to generate electricity according to the present invention.

FIG. 8 illustrates one embodiment of the present process where all of the hydrogen and oxygen are provided from other source(s) and/or process(es) to be combusted to produce fresh water. The heat extracted from the superheated steam can be used to generate electricity or be used in a industrial/chemical process according to the present invention.

FIG. 9 illustrates one embodiment of the present process where hydrogen and oxygen are provided from other source(s) and/or process(es), in addition to the hydrogen and oxygen that is generated by the high temperature electrolysis. The combined generated and provided hydrogen and oxygen are combusted to produce superheated steam and heat. The heat extracted from the superheated steam can be used to compensate for the heat losses in the system, to generate electricity and/or be used in an industrial/chemical process according to the present invention.

FIG. 10 illustrates the impact of temperature on the contribution of heat and electricity according to the present invention, and

FIG. 11 illustrates a further embodiment of a system according to the present invention where the evaporator and the electrolysis units are separated.

### DESCRIPTION OF THE PREFERRED EMBODIMENT

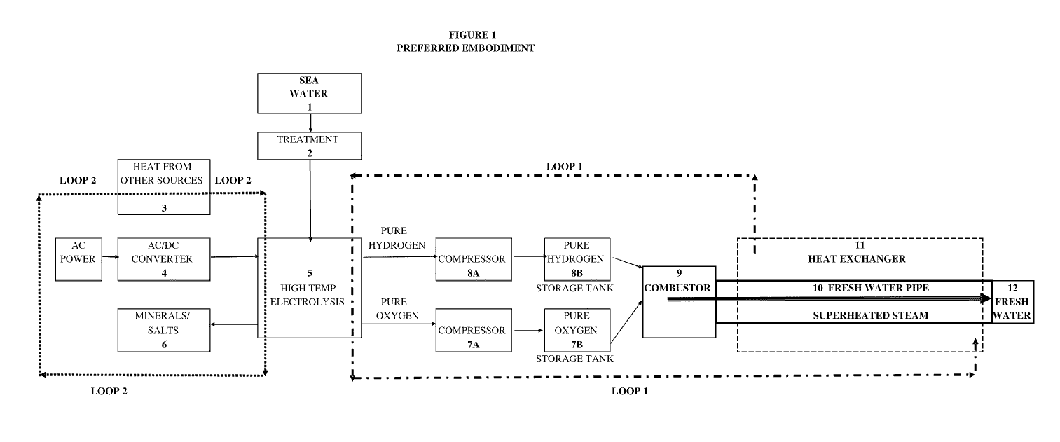

Referring initially to FIG. 1, in one embodiment, of the present invention all of the hydrogen and oxygen that is generated by the high temperature electrolysis process is combusted to produce superheated steam and heat. The heat generated through the combustion of hydrogen and oxygen is then extracted by the heat exchanger system and is recycled to be used in the high temperature electrolysis process. The extraction of the heat by the heat exchanger system condenses the superheated steam into fresh water.

The process can be summarized as follows:

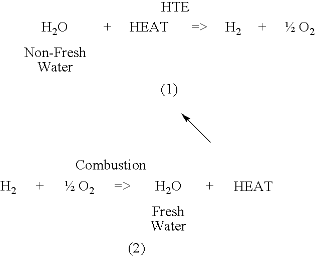

As shown in equation (1), non fresh water is heated to create supersaturated steam and using the high temperature electrolysis process the supersaturated steam is separated into hydrogen and oxygen. The generated hydrogen and oxygen is then combusted to create supersaturated steam and heat as shown in equation (2). The heat generated by the process of combustion of hydrogen and oxygen is then recovered to be used for the required heat in the high temperature electrolysis process.

Seawater 1 is first taken to a treatment station 2. Seawater is treated to remove organics, algae and particulate such as sand. Fine particles are removed if brackish water is used as the input water. Waste material is removed if waste or polluted water is used as the input water. Conventional processes can be used for such removal as will be understood by those of ordinary skill in the art.

The next step in the process is the high temperature electrolysis process 5. In this stage, the seawater is electrolyzed into hydrogen and oxygen. The electrolysis process is through high temperature electrolysis, in which the seawater is heated to a very high temperature and as a result, only a relatively small amount of electricity is required to cause the hydrogen and oxygen to separate and flow in different channels after decomposition. The required heat for the high temperature electrolysis is provided from the combustion of hydrogen and oxygen in a later stage of the process. The required electricity for the electrolysis process, whose only purpose is to separate hydrogen and oxygen, can be purchased from an outside source or may even be produced by utilizing the excess heat produced at various stages of the present method. Alternatively, the excess heat can be used as an energy input for an electricity generator such as a steam turbine and the energy produced can be sold. High temperature electrolysis is an established process and consequently, the selection of electrodes and the construction of HTE units are within the knowledge of a person of ordinary skill in the art.

FIG. 1 illustrates, heat from combustion, the addition of heat 3 (if required), and electricity 4 are provided to the high temperature electrolysis unit 5. The high temperature electrolysis unit contains two sections, the evaporation chamber and the high temperature electrolysis section. Additional heat from outside sources may be required so as to compensate for any heat losses in the system such as heat exchanger inefficiencies. Electricity, whose sole purpose will be to separate the hydrogen and oxygen, will be negligible and may be purchased from outside sources or generated by capturing the lost heat at various stages in the plant. External sources, such as energy from wind, solar, fossil fuel, nuclear and geothermal sources can be used to compensate for the heat losses and/or supply the minimal electrical need to separate the hydrogen and oxygen.

The treated seawater is taken into the evaporation chamber section where the treated water is turned into steam by the addition of the recycled heat (carried by suitable piping) from the combustion of hydrogen and oxygen in a later stage of the process. The purpose of the separate evaporation chamber section is to stage the heating of the treated water thereby separating the water from the salts, mineral and other contaminants by evaporating the water component of the treated water into steam and then subjecting the steam to extreme temperatures, around 2500° C. in the high temperature electrolysis section. Consequently, the steam in the evaporation chamber section will be substantially pure and will not contain salts, minerals or other contaminants. As a result of thermal expansion the steam then flows into the high temperature electrolysis section where additional heat is added. Salt, minerals and other contaminants at the bottom 6 of the HTE unit are removed, preferably continuously.

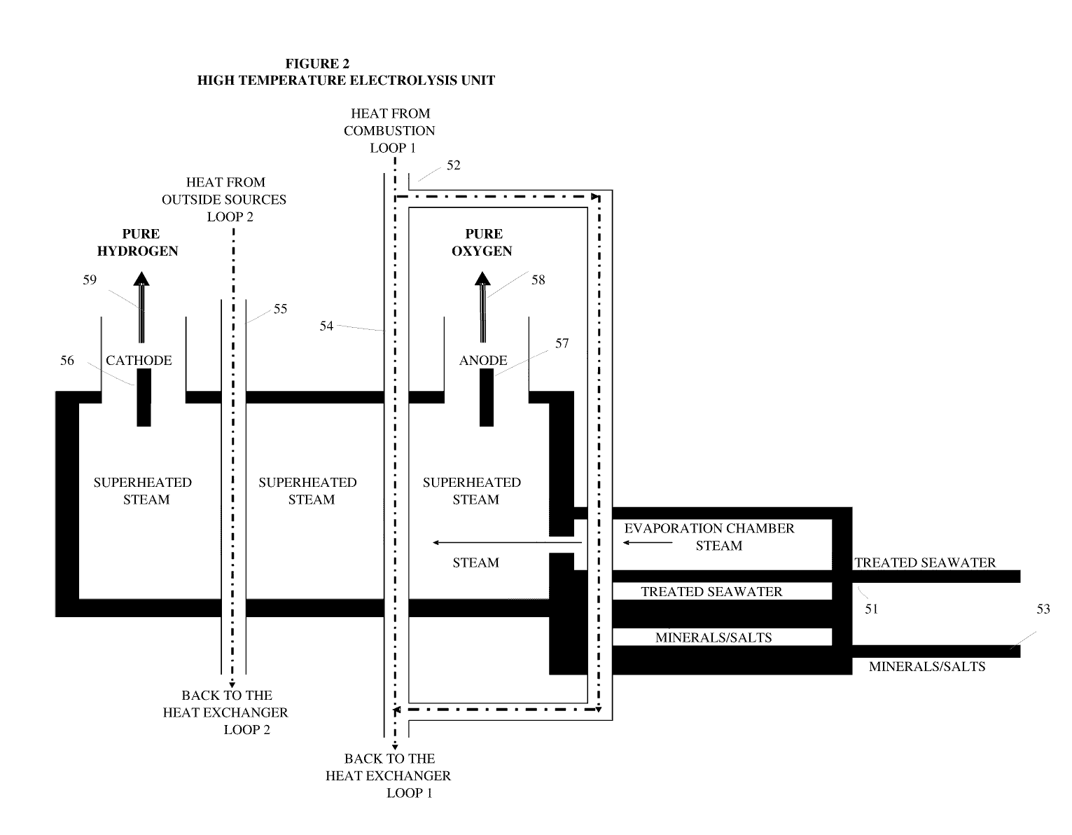

As shown in FIG. 2, treated seawater enters the evaporation chamber section of the HTE unit at 51. Some heat is diverted from the recycled combustion heat at 52 and it heats up the treated seawater to create steam. The remaining salts and minerals are removed, preferably continuously from the evaporation chamber at 53. The recovered salts and minerals can be sold thereby providing an additional source of revenue. As a result of thermal expansion, the steam in the evaporator chamber section will then flow into the high temperature electrolysis section of the HTE unit 5 where additional heat is added to the steam through a heat exchanging system 55 and 54. Most of the heat needed for this process is generated internally 54 through loop 1 that recycles the heat that is provided by the combustion of the hydrogen and oxygen in a later stage of the process. Any additional heat, if needed, comes from external sources 55 through loop 2. Two electrodes, cathode 56 and anode 57 located inside the HTE unit 5 act to separate the oxygen 58 and hydrogen 59.

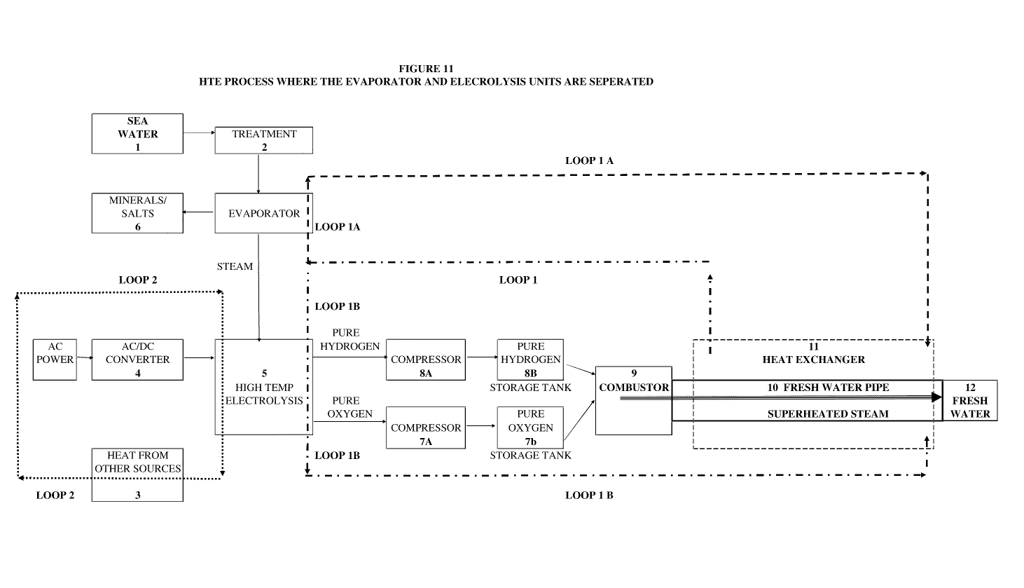

In an alternate embodiment of the present invention as shown in FIG. 11, the evaporation chamber section and the high temperature electrolysis section can be two separate equipment units rather than two sections within the same unit.

In an alternate embodiment of the present invention, the evaporation chamber section in the HTE unit may not be employed. In this situation all of the heating occurs in the high temperature electrolysis section.

Preferably, the HTE unit 5 and the heat exchanger 11 are insulated so as to minimize heat loss and maximize their efficiencies. There are several methods of constructing high temperature electrolysis systems. One method is described by Jensen, Larsen and Mogensen, the details of which are incorporated herein by reference (International Journal of Hydrogen Energy, 32 (2007) 3253-3257.

Once hydrogen and oxygen are generated by the HTE unit 5, they are separated into different storage tanks under pressure. Pressure is used so as to minimize the amount of the required storage. A compressor 7a is used to move oxygen into a storage tank 7b, and a compressor 8a is used to move hydrogen into a storage tank 8b.

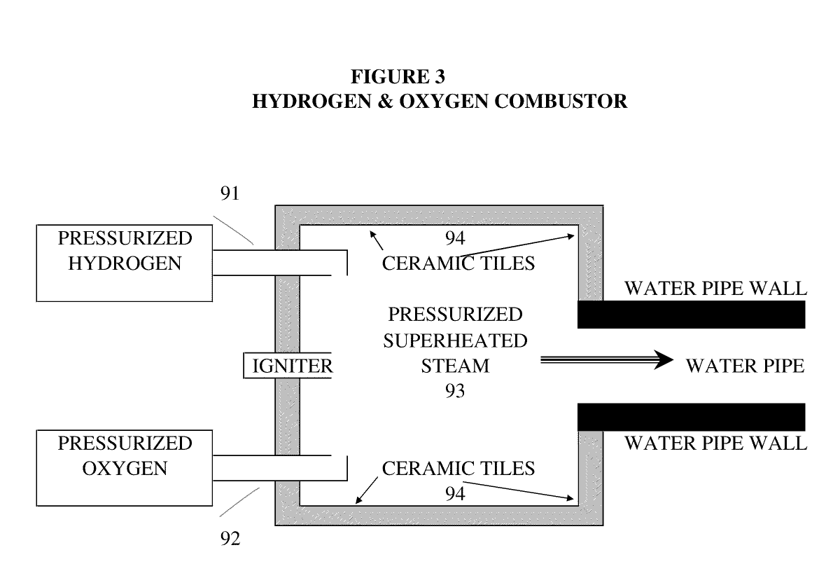

As shown in FIG. 3, pressurized hydrogen 91 and pressurized oxygen 92 are then injected into a combustor 9 to generate superheated steam 93. The pressurized hydrogen and oxygen ensures that the combustion will occur under high pressure thus preventing air from entering the combustor thereby preventing the creation of nitrous oxide (“NOX”). The combustion chamber is designed to withstand high combustion temperatures without significant heat loss. The combustion chamber is preferably constructed of refractory materials or has high temperature ceramic surface coatings 94. Another means for carrying out high temperature combustion is described in U.S. Pat. No. 7,128,005, details of which are incorporated herein by reference. The combustion process produces superheated steam at high temperatures. The heat from the superheated steam is extracted through a heat exchanger 11. The material in the system is chosen from material that is suitable for high temperature operation. Current technology has the capacity to deal with heat in excess of 2500° C. For example, there are ceramics that can withstand the heat and thus could line the surface of the combustor, the appropriate selection of which is within the knowledge of a person of ordinary skill in the art.

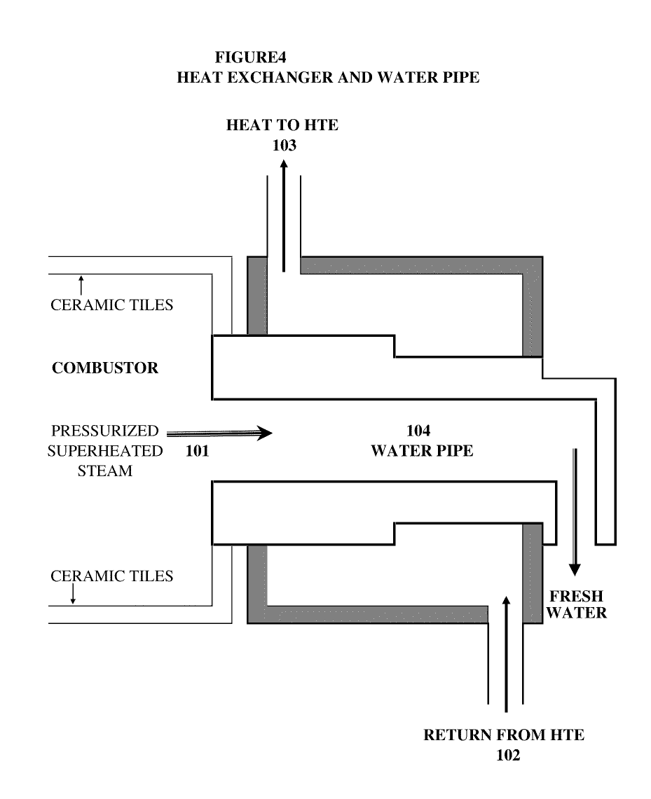

As shown in FIG. 4, the superheated steam 101 so produced is at a combustion temperature of about 2500° C. This high temperature superheated steam then flows through a water pipe 10, transferring heat to a high temperature heat exchanger system 11. The returned heat exchanger fluid enters the heat exchanger system at 102. The heat energy extracted by the heat exchanger system from the high temperature superheated steam is then returned to the high temperature electrolysis unit 103 to heat the treated seawater through loop 1. The superheated steam produced by the combustion process is cooled by the extraction of the heat by the heat exchanger system to produce fresh water 12. The water pipe 104 serves the purpose of containing the superheated steam isolated so that no impurities are introduced into the process of fresh water creation. The water pipe and the combustor are hermetically sealed thereby ensuring that no air or contaminants will enter the process. The superheated steam exiting from the combustor to the water pipe is also under pressure thus ensuring that no air will enter the water pipe.

The wall thickness of the water pipe can be tapered as the temperature gradient reduces along the water pipe due to heat extraction. The tapered wall reduces the cost of the water pipe. Heat is extracted from the water pipe by way of suitable heat exchangers. The combustor and the water pipe containing high temperature superheated steam and are made of material that can stand high temperatures, such as refractory material. The heat exchanger fluid is not in direct contact with the super saturated steam. Nuclear plants operate at very high temperatures and consequently, the selection of appropriate heat exchanger and heat exchanger fluids suitable for the Rosenbaum-Weisz Process is within the knowledge of a person of ordinary skill in the art.

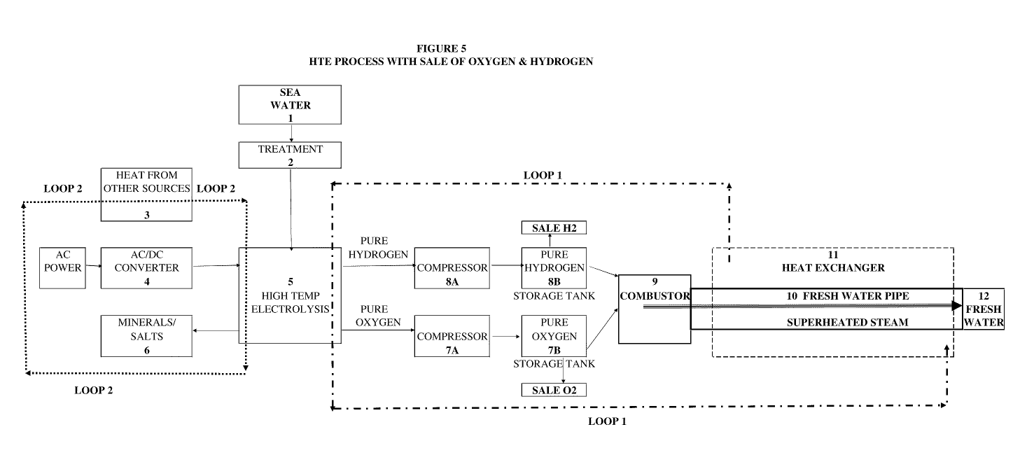

In another embodiment of the present invention as illustrated in FIG. 5, some of the hydrogen and oxygen is sold rather than be used to generate heat. Some of the oxygen and hydrogen are extracted from the storage tanks 7b and 8b for external use. Thus, this process can be used to generate hydrogen for the hydrogen economy. The selling of some of the hydrogen and oxygen implies that less hydrogen and oxygen is combusted in the combustor. The extraction of hydrogen and oxygen results in reducing the amount of heat available to the HTE from the combustion of hydrogen and oxygen. Thus, the reduction of the heat from the combustion can be made up by increasing the amount of heat and or electricity that would be required to be purchased from outside sources. The amount of hydrogen that can be sold is a function of the difference in the sum of the cost of purchasing heat and/or electricity and the reduction of fresh water revenue versus the revenue that could be generated by the sale of hydrogen and oxygen.

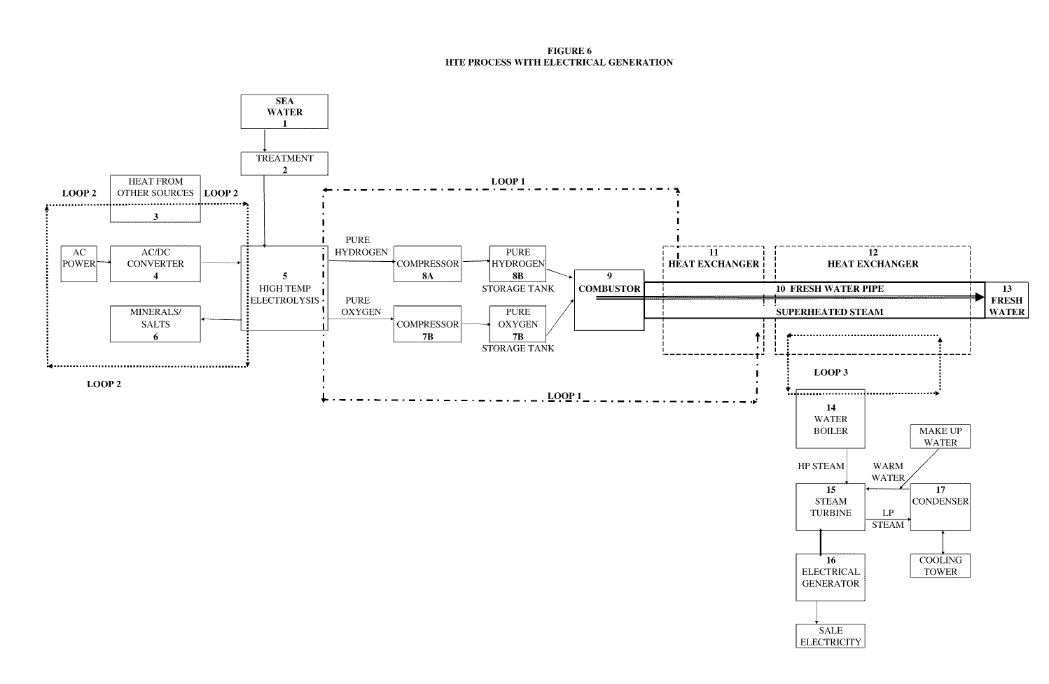

Another embodiment of the present invention is illustrated in FIG. 6, where some of the heat that is generated by the combustion of hydrogen and oxygen can be diverted to a steam generator to be converted by a steam turbine into electricity. All of the hydrogen and oxygen are used for combustion. There is no sale of hydrogen or oxygen. Part of the combustion heat is captured through another heat exchanger 12 and carried through loop 3 to a steam generator 14. The generated steam is then taken to a steam turbine 15 to generate electricity 16. The extraction of the heat to generate electricity will result in reducing the amount of heat available to the HTE from the combustion of hydrogen and oxygen. Thus, the reduction of the heat from the combustion can be made up by increasing the amount of heat and/or electricity that would be required to be purchased from outside sources. One reason that one would do this is because some of the generated electricity may be classified as “green electricity” thereby enabling the plant to get a high premium price for the generated electricity. This is an arbitrage situation. Typically, however, the capital cost required for the generation of electricity would make it uneconomical to generate and sell electricity unless there was a premium paid for the generated electricity.

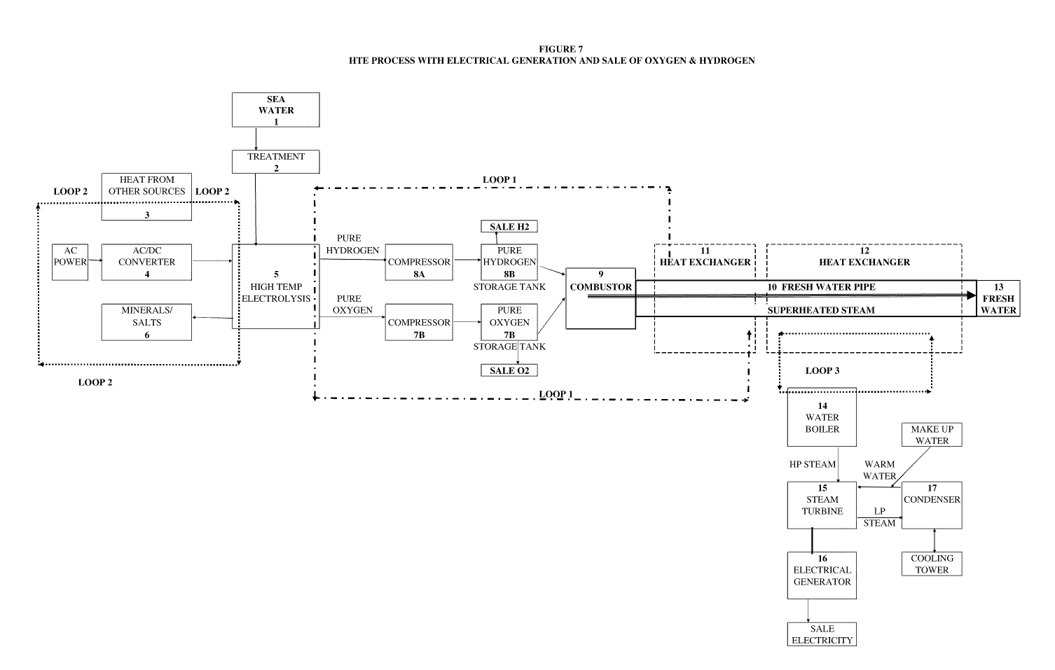

Another embodiment of the present invention as shown in FIG. 7 is a combination of extraction of hydrogen and oxygen as well as producing electricity.

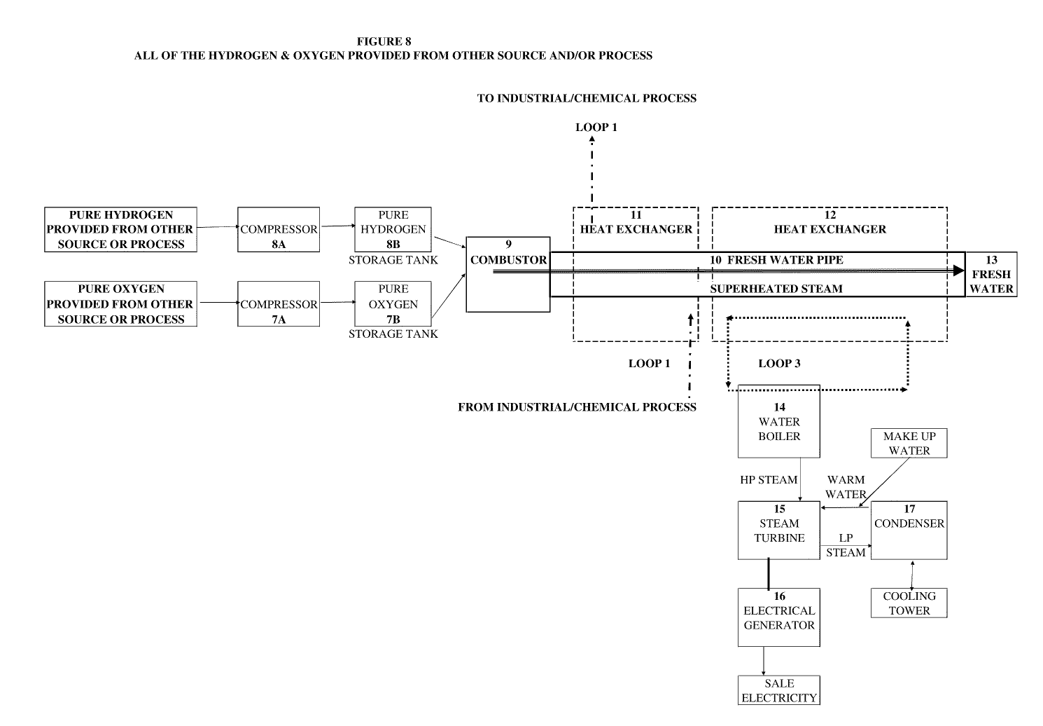

Another embodiment of the present invention as shown in FIG. 8 illustrates a process where all of the hydrogen and oxygen are provided from a source and/or process other than HTE to be combusted to produce fresh water. Hydrogen can be produced by extraction from hydrocarbon fossil fuels via a chemical path. Hydrogen may also be extracted from water via biological production in an algae bio-reactor, Similarly, oxygen can be obtained by fractional distillation of liquid air. The imported hydrogen and oxygen are then combusted to produce superheated steam and heat. The heat extracted from the superheated steam can be used to generate electricity or be used in a industrial/chemical process.

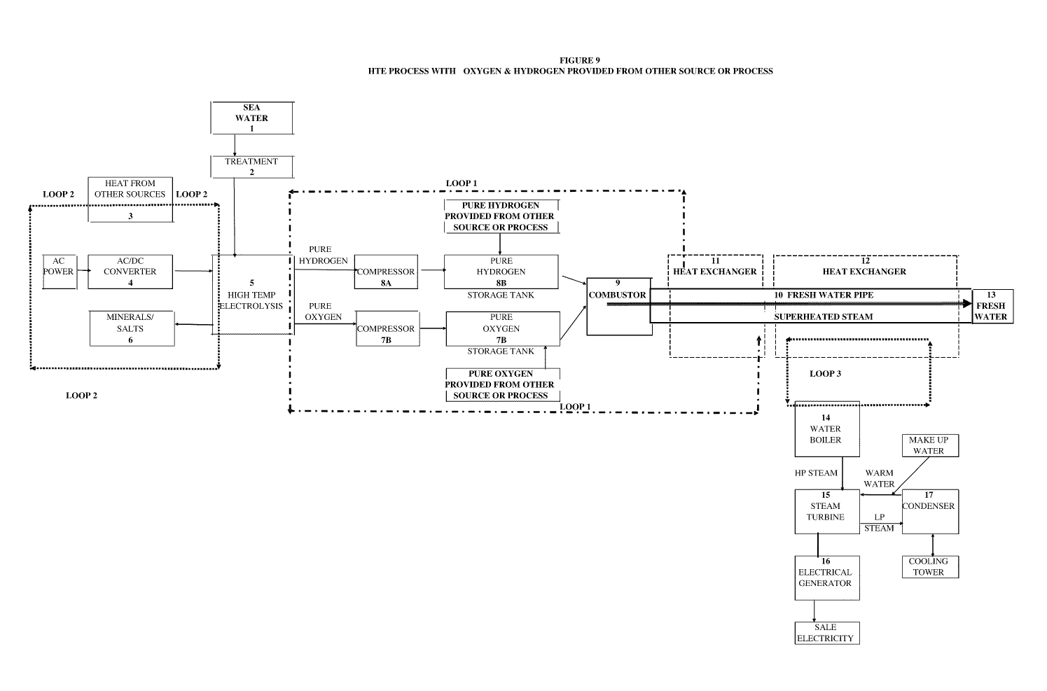

Another embodiment of the present invention as shown in FIG. 9 illustrates a process where hydrogen and oxygen are provided from other source(s) and/or process(es) and the hydrogen and oxygen that is produced by the high temperature electrolysis are combined to be combusted to produce superheated steam and heat. The heat extracted from the superheated steam can be used to compensate for the heat losses in the system, generate electricity and/or be used in a industrial/chemical process. This may be done where the cost of the additional hydrogen and oxygen is less than the purchase of heat from other sources to compensate for the heat losses in the system. Another reason for doing this is if the revenue from electricity produced exceeds the cost of the additional hydrogen and oxygen.

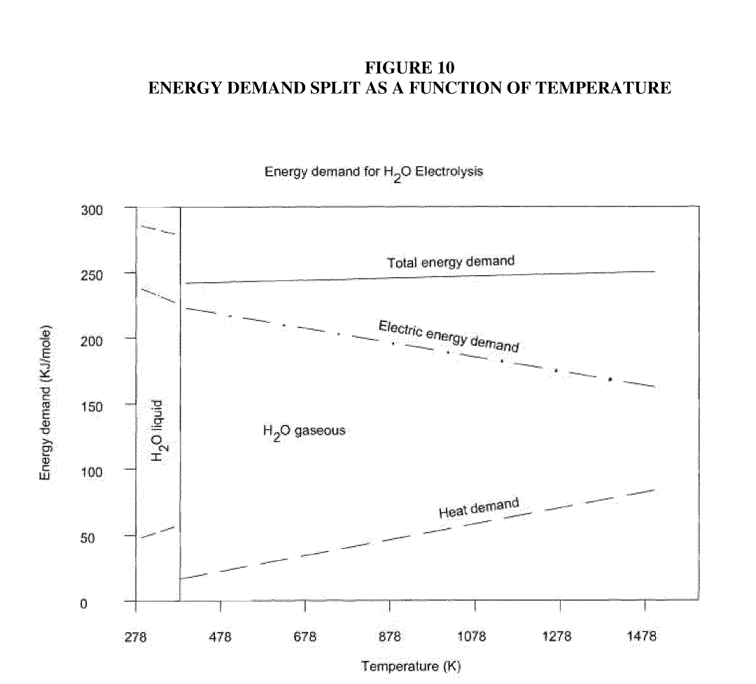

To demonstrate the ability of this method to minimize the electricity usage for hydrogen and oxygen production two sample cases have been considered. FIG. 10 illustrates the relationship between the contribution of heat and electricity as a function of temperature. The temperature range is consistent with the typical temperature of the waste heat from a cogeneration plant. Extrapolating the relationship, for electrolysis occurring at 1500° C., it is estimated that 50% of the required energy will come from heat and 50% from electricity (Case A). If the electrolysis occurs at 2000° C. then it is estimated that 75% of the required energy comes from heat and 25% from electricity (Case B). It should be noted that heat usage can go much higher to 99% if the electrolysis is at around 2500° C.

The above cases clearly demonstrate that electricity purchases are significantly reduced even in the cases where only 75% of the energy requirement comes from heat. For the proposed invention where approximately 99% energy will be provided from the heat generated by the combustion of hydrogen and oxygen. It can be easily predicted that electricity purchase, whose sole purpose will be to separate the hydrogen and oxygen, will be negligible.

In an alternate embodiment, the system and process of the present invention with appropriate modification can be used with a sewage treatment plant to eliminate impurities and hazardous materials in the non-fresh water being processed.

It will be understood by those skilled in the art that the process of the present invention can be used on a variety of scales such as from a small plant that purifies water in a small village to large desalination plant providing fresh water to a major metropolitan city.

It will be further understood by those skilled in the art that the system of the present invention can be configured in a number of ways. For example, in certain embodiments, multiple units can be used such as, but not limited to, two HTE units, three combustors, and four heat exchangers.

While preferred processes are described, various modifications, alterations, and changes may be made without departing from the spirit and scope of the process according to the present invention as defined in the appended claims. Many other configurations of the described processes may be useable by one skilled in the art.

What is claimed is:

1. A method of converting non-fresh water to fresh water, comprising the steps of:
(a) subjecting the non-fresh water to high temperature electrolysis whereby hydrogen gas and oxygen gas are produced;
(b) combusting the hydrogen gas and the oxygen gas at elevated pressure to produce superheated steam and heat; and
(c) condensing the superheated steam to produce fresh water.

2. The method of claim 1, further including the steps of
(d) recovering heat from the superheated steam and
(e) using the recovered heat as an energy input in step (a).

3. The method of claim 2, the recovery of heat in step (d) uses a heat exchange process.

4. The method of claim 3, further including the step of pre-treating the non-fresh water.

5. The method of claim 4, wherein the pre-treatment step includes removing from the non-fresh water a component selected from the group consisting of salts, minerals, waste material and other impurities.

6. The method of claim 5, further including the step of selling the salts or minerals.

7. The method of claim 4, further including the step of
(f) pre-heating the treated seawater prior to step (a).

8. The method of claim 7, further including in step (f), elevating the treated seawater to a temperature sufficient to create steam and supplying the steam for step (a).

9. The method of claim 7, further including the step of using at least some of the recovered heat of step (d) for step (f).

10. The method of claim 1, further including the steps of
(g) recovering heat from the superheated steam,
(h) using some of the recovered heat as an energy input in step (a), and
(i) using some of the recovered heat as an energy input for another process.

11. The method of claim 10, wherein the process is the production of electricity.

12. The method of claim 11, wherein the production of electricity includes using the heat of step (i) to heat water to create steam to run a steam turbine.

13. The method of claim 1, further including the steps of
recovering heat from the superheated steam and
using the recovered heat as an energy input in another process.

14. The method of claim 13, wherein the process is the production of electricity.

15. The method of claim 14, further including the step selected from the group consisting selling and using at least some of the electricity produced.

16. The method of claim 1, wherein the high temperature electrolysis occurs at elevated temperatures.

17. The method of claim 1, wherein step (b) is carried out at elevated pressure.

18. The method of claim 17, wherein step (a) is carried out at elevated pressure.

19. The method of claim 1, further including the step of supplying energy for step (a) at least partially from an external source.

20. The method of claim 19, wherein the external source of energy is selected from group consisting of solar energy, wind energy, nuclear energy, fossil fuel energy, and geothermal energy.

21. The method of claim 1, further including the step of removing part of the generated hydrogen and oxygen of step (a) whereby the removed hydrogen and oxygen are not used in step (b).

22. The method of claim 21, further including the step of selling at least some of the removed hydrogen and oxygen.

23. The method of claim 1, wherein the non-fresh water is selected from the group consisting of seawater, brackish water, waste water and polluted water.

24. The method of claim 1, wherein additional hydrogen and oxygen are supplied for step (b) from a source other than the high temperature electrolysis of step (a).

25. A system for producing fresh water comprising:
a hydrogen and oxygen combustor for producing high temperature superheated steam;
a condenser for condensing superheated steam.

26. The system of claim 25, wherein the condenser includes a heat exchanging unit for recovering heat from the superheated steam.

27. The system of claim 25, wherein the combustor is made of refractory material.

28. The system of claim 25, further including a high temperature electrolysis unit for receiving non-fresh water and for producing hydrogen and oxygen gas from the non-fresh water.

29. The system of claim 28, further including means for transferring the recovered heat to the high temperature electrolysis unit.

30. The system of claim 28, further including a pretreatment unit for pre-treating the non-fresh water.

31. The system of claim 30, wherein the electrolysis unit further includes an evaporation chamber section.

32. The system of claim 31, wherein the evaporation chamber section is a unit separate from the electrolysis unit.

33. The system of claim 30, further including an industrial unit and first and second heat exchanging units, the first unit in energy communication with the high temperature electrolysis unit and the second unit in energy communication with the industrial unit, whereby heat recovered from the first unit is used as an energy input for the high temperature electrolysis unit and heat recovered from the second unit is used as an energy input for the industrial unit.

34. The system according to claim 33, wherein the industrial unit is an electricity generating unit.

35. A method of producing fresh water, comprising the steps of:
(a) combusting hydrogen gas and the oxygen gas at greater than atmospheric pressure to produce superheated steam; and
(b) condensing the superheated steam to produce fresh water.

36. The method of claim 35, further including the step of (c) recovering heat from the superheated steam.

37. The method of claim 36, wherein the recovery of heat in step (c) uses a heat exchange process.

38. The method of claim 35, further including the step of using the recovered heat as an energy input for another industrial process.

39. The method of claim 35, wherein the hydrogen and oxygen are provided from a source other than high temperature electrolysis.

40. The system of claim 26, further including a water pipe connected to the combustor for collecting condensed water and wherein the water pipe is hermetically sealed.

41. The system of claim 40, wherein the thickness of wall of the water pipe is tapered along its length.

42. The system of claim 41, wherein the water pipe is adapted to operate under elevated pressure and elevated temperature.

43. The method of claim 38, wherein the industrial process is the generation of electricity.

44. The method of claim 43, further including a step selected from the group consisting of selling and using at least some of the electricity produced.

45. The method of claim 24, further including the steps of
(j) recovering heat from the superheated steam, and
(k) using some of the recovered heat as an energy input for another process.

46. The method of claim 45, wherein the process is the generation of electricity.

47. The method of claim 46, further including a step selected from the group consisting of selling and using at least some of the electricity produced.
